(19) United States
(12) Patent Application Publication
(10) Pub. No.: US 2019/0064344 A1
(43) Pub. Date: Feb. 28, 2019

(54) Use of body-worn radar for biometric measurements, contextual awareness and identification

(71) Applicant: BRAGI GmbH, Munchen (DE)

(72) Inventor: Jake Berry Turner, Munchen (DE)

(73) Assignee: BRAGI GmbH, Munchen (DE)

(21) Appl. No.: 15/926,108

(22) Filed: Mar. 20, 2018

Related U.S. Application Data
(60) Provisional application No. 62/475,009, filed on Mar. 22, 2017.

(51) Int. Cl. G01S 13/93; G08B 25/01; G08B 21/02; H04R 1/10

(52) U.S. Cl. CPC G01S 13/93; G08B 25/016; H04R 1/1058; H04R 1/1016; G08B 21/02

(57) ABSTRACT

A method for utilizing wireless earpieces with radar in embodiments of the present invention may have one or more of the following steps: (a) activating one or more radar sensors of the wireless earpieces, (b) performing radar measurements of a user, (c) analyzing the radar measurements to determine contextual awareness for the user, (d) sending the contextual awareness information to the user, (e) sending the contextual awareness information to a body area network (BAN), (f) contacting emergency assistance authorities if the externally facing radar detects an impact to the user, (g) audibly communicating information associated with the contextual information to the user through the wireless earpieces, and (h) notifying the user of close quarter objects.

### PRIORITY STATEMENT

This application claims priority to U.S. Provisional Patent Application No. 62/475,009 filed on Mar. 22, 2017 titled Use of Body-Worn Radar for Biometric Measurements, Contextual Awareness and Identification; all of which is hereby incorporated by reference in its entirety.

### FIELD OF THE INVENTION

The illustrative embodiments relate to wearable devices. Particularly, the illustrative embodiments relate to wireless earpieces. More particularly, but not exclusively, the illustrative embodiments relate to wireless earpieces having radar capabilities.

### BACKGROUND

The growth of wearable devices is increasing exponentially. This growth is fostered by the decreasing size of microprocessors, circuity boards, chips, and other components. In some cases, wearable devices may obtain biometric data. An important aspect of biometric data may be determining user safety, activities, and conditions. In some cases, this information is stored only temporarily for communication to the user.

Radar is an object-detection system using radio waves to determine the range, angle, or velocity of objects. It can be used to detect aircraft, ships, spacecraft, guided missiles, motor vehicles, weather formations, and terrain. A radar system consists of a transmitter producing electromagnetic waves in the radio or microwaves domain, a transmitting antenna, a receiving antenna (often the same antenna is used for transmitting and receiving) and a receiver and processor to determine properties of the object(s). Radio waves (pulsed or continuous) from the transmitter reflect off the object and return to the receiver, giving information about the object's location and speed.

Radar was developed secretly for military use by several nations in the period before and during World War II. A key development was the cavity magnetron in the UK, which allowed the creation of relatively small systems with sub-meter resolution. The term RADAR was coined in 1940 by the United States Navy as an acronym for Radio Detection And Ranging or Radio Direction And Ranging. The term radar has since entered English and other languages as a common noun, losing all capitalization.

The modern uses of radar are highly diverse, including air and terrestrial traffic control, radar astronomy, air-defense systems, antimissile systems, marine radars to locate landmarks and other ships, aircraft anti-collision systems, ocean surveillance systems, outer space surveillance and rendezvous systems, meteorological precipitation monitoring, altimetry and flight control systems, guided missile target locating systems, ground-penetrating radar for geological observations, and range-controlled radar for public health surveillance. High tech radar systems are associated with digital signal processing, machine learning and can extract useful information from very high noise levels.

Other systems like radar make use of other parts of the electromagnetic spectrum. One example is “lidar”, which uses predominantly infrared light from lasers rather than radio waves.

It is desirable to use radar and variations of radar for use in obtaining biometric data, contextual awareness and identification for wearable devices.

### SUMMARY

Therefore, it is a primary object, feature, or advantage of the present invention to improve over the state of the art.

A method for utilizing wireless earpieces with radar in embodiments of the present invention may have one or more of the following steps: (a) activating one or more radar sensors of the wireless earpieces, (b) performing radar measurements of a user, (c) analyzing the radar measurements to determine contextual awareness for the user, (d) sending the contextual awareness information to the user, (e) sending the contextual awareness information to a body area network (BAN), (f) contacting emergency assistance authorities if the externally facing radar detects an impact to the user, (g) audibly communicating information associated with the contextual information to the user through the wireless earpieces, and (h) notifying the user of close quarter objects.

A wireless earpiece in embodiments of the present invention may have one or more of the following features: (a) a housing for fitting in an ear of a user, (b) a processor controlling functionality of the wireless earpiece, (c) a plurality of sensors performs sensor measurements of the user, wherein the plurality of sensors includes one or more radar sensors, (d) a transceiver communicating with at least a wireless device wherein the processor activates the one or more radar sensors and analyzes the radar measurements to determine contextual awareness associated with the user.

A method for utilizing wireless earpieces with radar in embodiments of the present invention may have one of more of the following steps: (a) activating an externally facing radar sensor of the wireless earpieces, (b) performing radar measurements, (c) analyzing the radar measurements to determine contextual awareness of the user's surroundings, (d) identifying any close objects to the user, (e) notifying the user of any close objects to the user, (f) notifying emergency service personal if an impact is detected, and (g) notifying the user of a quickly closing object as a potential impact hazard.

One or more of these and/or other objects, features, or advantages of the present invention will become apparent from the specification and claims follow. No single embodiment need provide every object, feature, or advantage. Different embodiments may have different objects, features, or advantages. Therefore, the present invention is not to be limited to or by any objects, features, or advantages stated herein.

### BRIEF DESCRIPTION OF THE DRAWINGS

Illustrated embodiments of the present invention are described in detail below with reference to the attached drawing figures, which are incorporated by reference herein, and where:

FIG. 1 is a pictorial representation of a communication system in accordance with an illustrative embodiment;

FIG. 2 is a pictorial representation of sensors of the wireless earpieces in accordance with illustrative embodiments;

FIG. 3 is pictorial representation of a right wireless earpiece and a left wireless earpiece of a wireless earpiece set in accordance with an illustrative embodiment;

FIG. 4 is a block diagram of wireless earpieces in accordance with an illustrative embodiment;

FIG. 5 is a flowchart of a process for performing radar measurements of a user utilizing wireless earpieces in accordance with illustrative embodiments;

FIG. 6 is a flowchart of a process for generating alerts in response to external radar measurements performed by the wireless earpieces;

FIG. 7 depicts a computing system in accordance with an illustrative embodiment; and

FIG. 8 is a pictorial illustration of a body area network with wearable devices capable of performing radar measurements in accordance with illustrative embodiments.

### DETAILED DESCRIPTION

The following discussion is presented to enable a person skilled in the art to make and use the present teachings. Various modifications to the illustrated embodiments will be plain to those skilled in the art, and the generic principles herein may be applied to other embodiments and applications without departing from the present teachings. Thus, the present teachings are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings. While embodiments of the present invention are discussed in terms of wireless earpieces, it is fully contemplated embodiments of the present invention could be used in most any wearable device without departing from the spirit of the invention.

One embodiment provides a system, method, and wireless earpiece for utilizing radar. One or more radar sensors of the wireless earpieces are activated. Radar measurements of a user are performed. The radar measurements are analyzed to determine biometrics associated with the user. In another embodiment, the wireless earpieces include a processor and a memory storing wireless earpiece operation, programing and data. The methods of operation and programming are executed by the processor to perform the method herein described.

Yet another embodiment provides a wireless earpiece. The wireless earpiece includes a housing for fitting in an ear of a user. The wireless earpiece further includes a processor controlling functionality of the wireless earpiece. The wireless earpiece further includes several sensors performing sensor measurements of the user. The number of sensors include one or more radar sensors. The wireless earpiece further includes a transceiver communicating with at least a wireless device. The processor activates the one or more radar sensors and analyzes the radar measurements to determine biometrics associated with the user.

The illustrative embodiments provide a system, method, and wireless earpieces for utilizing radar to detect user biometrics. In one embodiment, the wireless earpieces worn to provide media content to a user may also capture user biometrics utilizing any number of sensors. The sensors may include a radar sensor utilized to detect biometrics, such as heart rate, blood pressure, blood oxygenation, heart rate variability, blood velocity and so forth. The wireless earpieces may represent any number of shapes and configurations, such as wireless earbuds or a wireless headset.

The radar sensor may be configured as an active, passive or combination sensor. In various embodiments, the radar sensor may be internally or externally focused. For example, internally focused radar sensors may perform any number of measurements, readings, or functions including, but not limited to, measuring/tracking the motion and orientation of a user or other target/body (e.g., translational, rotational displacement, velocity, acceleration, etc.), determining material properties of a target/body, and determining a physical structure of a target/body (e.g., layer analysis, depth measurements, material composition, external and internal shape, construction of an object, etc.). The specific measurements of the wireless earpieces may be focused on user biometrics, such as heart rate, blood flow velocity, status of the wireless earpieces (e.g., worn, in storage, positioned on a desk, etc.), identification of the user, and so forth. The utilization of radar in the wireless earpieces may be beneficial because of insensitivity to ambient light, skin pigmentation, and because direct sensor-user contact is not required. The utilization of radar sensors may also allow the sensors to be completely encapsulated, enclosed, or otherwise integrated in the wireless earpieces shielding the radar sensors from exposure to sweat/fluids, water, dirt, and dust.

The illustrative embodiments may utilize the Doppler frequency of the blood flow velocity determined from a composite signal detected by the sensors of the wireless earpieces. Utilization of radar sensors may provide for more reliable detection of whether the wireless earpieces are being worn in the ears of the user. The wireless earpieces may also detect a location, such as in a pocket, on a desk, in a hand, in a bag, in a smart charger, within a container, or so forth. The location determined by the radar sensors may also be synchronized with a wireless device in the event the user forgets or misplaces the wireless earpieces, so a record of the last known position or estimated position is recorded.

The illustrative embodiments may also determine whether the user is an authorized user utilizing a radar signature determined by the radar sensors. For example, the radar sensors may determine the size and shape of the users inner and outer ear as well as other facial structures, such as cheek shape, jaw bone and muscle arrangements, and so forth. In addition, the wireless earpieces may be utilized alone or as a set. When utilized as a set, the signals or determinations may be combined to determine information, such as the orientation of the left wireless earpiece and the right wireless earpiece relative to one another and the user's head, distance between the wireless earpieces, motion of the wireless earpieces relative to one another and the user's head, and so forth.

The illustrative embodiments may also be applicable to any number of other wearable devices, systems, or components, such as smart watches, headsets, electronic clothing/shoes, anklets, or so forth. As noted, both internally facing (toward the user) and externally facing radar sensors may be utilized. The wireless earpieces may communicate with any number of communications or computing devices (e.g., cell phones, smart helmets, vehicles, emergency beacons, smart clothing, emergency service personnel, designated contacts, etc.).

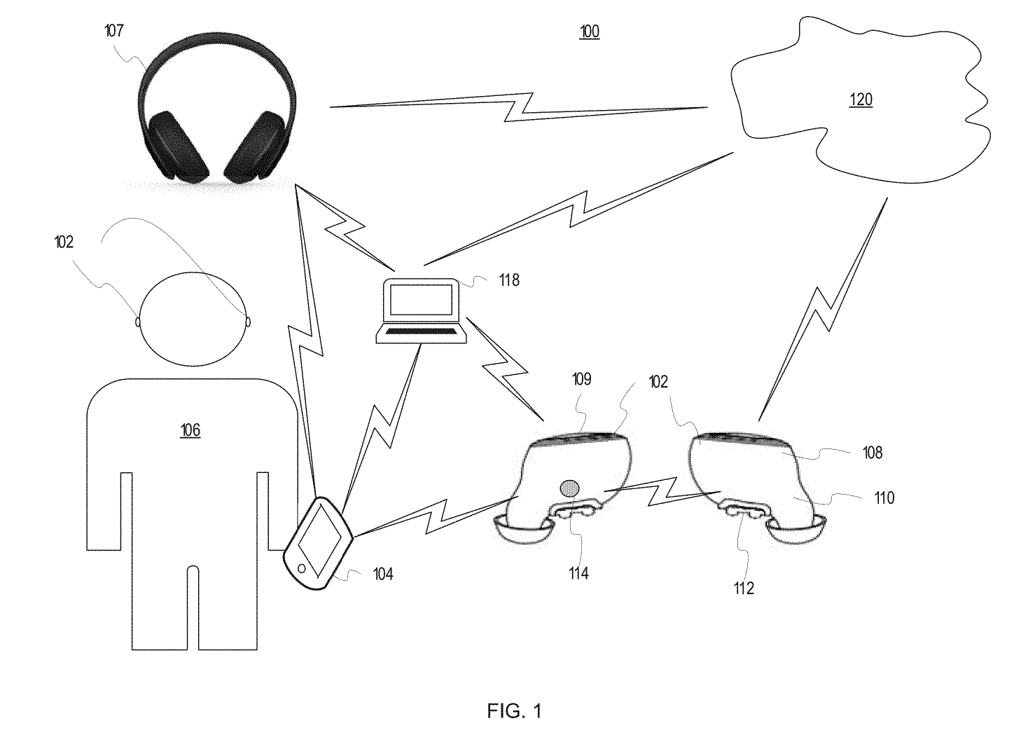

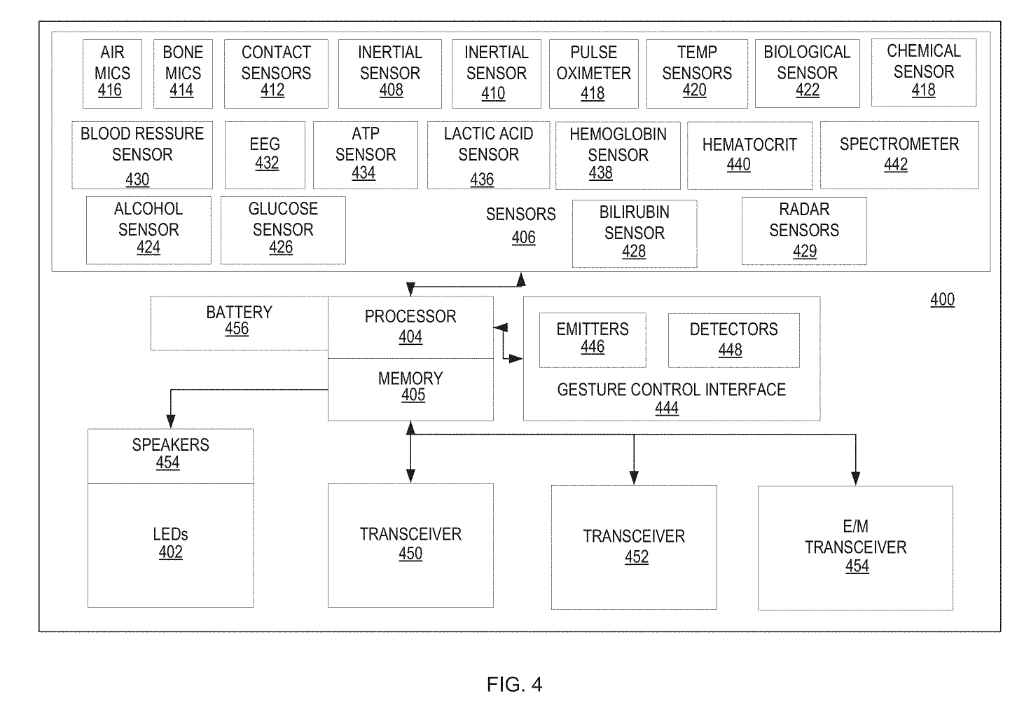

FIG. 1 is a pictorial representation of a communications environment 100 in accordance with an illustrative embodiment. The wireless earpieces 102 may be configured to communicate with each other and with one or more wireless devices, such as a wireless device 104 or a personal computer 118. The wireless earpieces 102 may be worn by a user 106 and are shown both as worn and separately from their positioning within the ears of the user 106 for purposes of visualization. A block diagram of the wireless earpieces 102 is further shown in FIG. 4 to further illustrate components and operation of the wireless earpieces 102 including the radar systems or components. The wireless earpieces 102 may be shaped and configured as wireless earbuds, wireless headphones 107, or other headpieces or earpieces any of which may be referred to generally as wireless earpieces 102.

In one embodiment, the wireless earpieces 102 includes a housing 108 shaped to fit substantially within the ears of the user 106. The housing 108 is a support structure at least partially enclosing and housing the electronic components of the wireless earpieces 102. The housing 108 may be composed of a single structure or multiple interconnected structures. An exterior portion of the wireless earpieces 102 may include a first set of sensors shown as infrared sensors 109. The infrared sensors 109 may include emitter and receivers detecting and measuring infrared light radiating from objects in its field of view. The infrared sensors 109 may detect gestures, touches, or other user input against an exterior portion of the wireless earpieces 102 visible when worn by the user 106. The infrared sensors 109 may also detect infrared light or motion. The infrared sensors 109 may be utilized to determine whether the wireless earpieces 102 are being worn, moved, approached by a user, set aside, stored in a smart case, placed in a dark environment or so forth.

The housing 108 defines an extension 110 configured to fit substantially within the ear of the user 106. The extension 110 may include one or more speakers or vibration components for interacting with the user 106. All or portions of the extension 110 may be removably covered by one or more sleeves. The sleeves may be changed to fit the size and shape of the user's ears. The sleeves may come in various sizes and have extremely tight tolerances to fit the user 106 and one or more other users may utilize the wireless earpieces 102 during their expected lifecycle. In another embodiment, the sleeves may be custom built to support the interference fit utilized by the wireless earpieces 102 while also being comfortable while worn. The sleeves are shaped and configured to not cover various sensor devices of the wireless earpieces 102.

In one embodiment, the housing 108 or the extension 110 (or other portions of the wireless earpieces 102) may include sensors 112 for sensing heart rate, blood oxygenation, temperature, heart rate variability, blood velocity, voice characteristics, skin conduction, glucose levels, impacts, activity level, position, location, orientation, as well as any number of internal or external user biometrics. In other embodiments, the sensors 112 may be positioned to contact or be proximate the epithelium of the external auditory canal or auricular region of the user's ears when worn. For example, the sensors 112 may represent various metallic sensor contacts, optical interfaces, radar, or even micro-delivery systems for receiving, measuring, and delivering information and signals. Small electrical charges, the Doppler effect, or spectroscopy emissions (e.g., various light wavelengths) may be utilized by the sensors 112 to analyze the biometrics of the user 106 including pulse, blood pressure, skin conductivity, blood analysis, sweat levels, and so forth. In one embodiment, the sensors 112 may include optical sensors emitting and measuring reflected light within the ears of the user 106 to measure any number of biometrics. The optical sensors may also be utilized as a second set of sensors to determine when the wireless earpieces 102 are in use, stored, charging, or otherwise positioned.

In one embodiment, the sensors 112 may include a radar sensor 114. The radar sensor 114 may be enclosed or encompassed entirely within the housing 108. In another embodiment, the radar sensor 114 may be a separate sensing component proximate the sensors 112 or positioned at one or more locations proximate the skin or tissue of the user. The radar sensor 114 may utilize any number of radar signals or technologies. For example, the radar sensor 114 may include millimeter-wave and/or terahertz radar systems. The radar sensor 114 may implement an important role in multimodal layered sensing systems targeted at measuring both physiological and behavioral biometric data. The illustrative embodiments may utilize the radar sensor 114 to detect blood pressure, heart rate variability, blood velocity, user identification, and so forth. The radar sensor 114 of both the left wireless earpiece and the right wireless earpiece may work in combination to ensure accurate readings are performed. Wireless earpieces 102 may utilize algorithms, error correction, and measurement processes, such as averaging, sampling, medians, thresholds, or so forth to ensure all measurements by the radar sensors 114 are accurate.

The sensors 112 may be utilized to provide relevant information communicated through the wireless earpieces 102. As described, the sensors 112 may include one or more microphones integrated with the housing 108 or the extension of the wireless earpieces 102. For example, an external microphone may sense environmental noises as well as the user's voice as communicated through the air of the communications environment 100. An ear-bone or internal microphone may sense vibrations or sound waves communicated through the head of the user 102 (e.g., bone conduction, etc.).

In some applications, temporary adhesives or securing mechanisms (e.g., clamps, straps, lanyards, extenders, etc.) may be utilized to ensure the wireless earpieces 102 remain in the ears of the user 106 even during the most rigorous and physical activities or to ensure if they do fall out they are not lost or broken. For example, the wireless earpieces 102 may be utilized during marathons, swimming, team sports, biking, hiking, parachuting, or so forth. In one embodiment, miniature straps may attach to the wireless earpieces 102 with a clip on the strap securing the wireless earpieces to the clothes, hair, or body of the user. The wireless earpieces 102 may be configured to play music or audio, receive and make phone calls or other communications, determine ambient environmental conditions (e.g., temperature, altitude, location, speed, heading, etc.), read user biometrics (e.g., heart rate, motion, temperature, sleep, blood oxygenation, voice output, calories burned, forces experienced, etc.), and receive user input, feedback, or instructions. The wireless earpieces 102 may also execute any number of applications to perform specific purposes. The wireless earpieces 102 may be utilized with any number of automatic assistants, such as Siri®, Cortana®, Alexa®, Google®, Watson®, or other smart assistants/artificial intelligence systems.

The communications environment 100 may further include the personal computer 118. The personal computer 118 may communicate with one or more wired or wireless networks, such as a network 120. The personal computer 118 may represent any number of devices, systems, equipment, or components, such as a laptop, server, tablet, medical system, gaming device, virtual/augmented reality system, or so forth. The personal computer 118 may communicate utilizing any number of standards, protocols, or processes. For example, the personal computer 118 may utilize a wired or wireless connection to communicate with the wireless earpieces 102, the wireless device 104, or other electronic devices. The personal computer 118 may utilize any number of memories or databases to store or synchronize biometric information associated with the user 106, data, passwords, or media content.

The wireless earpieces 102 may determine their position with respect to each other as well as the wireless device 104 and the personal computer 118. For example, position information for the wireless earpieces 102 and the wireless device 104 may determine proximity of the devices in the communications environment 100. For example, global positioning information or signal strength/activity may be utilized to determine proximity and distance of the devices to each other in the communications environment 100. In one embodiment, the distance information may be utilized to determine whether biometric analysis may be displayed to a user. For example, the wireless earpieces 102 may be required to be within four feet of the wireless device 104 and the personal computer 118 to display biometric readings or receive user input. The transmission power or amplification of received signals may also be varied based on the proximity of the devices in the communications environment 100.

In one embodiment, the wireless earpieces 102 and the corresponding sensors 112 (whether internal or external) may be configured to take several measurements or log information and activities during normal usage. This information, data, values, and determinations may be reported to the user or otherwise utilized as part of the virtual assistant. The sensor measurements may be utilized to extrapolate other measurements, factors, or conditions applicable to the user 106 or the communications environment 100. For example, the sensors 112 may monitor the user's usage patterns or light sensed in the communications environment 100 to enter a full power mode in a timely manner. The user 106 or another party may configure the wireless earpieces 102 directly or through a connected device and app (e.g., mobile app with a graphical user interface) to set power settings (e.g., preferences, conditions, parameters, settings, factors, etc.) or to store or share biometric information, audio, and other data. In one embodiment, the user may establish the light conditions or motion activating the full power mode or may keep the wireless earpieces 102 in a sleep or low power mode. As a result, the user 106 may configure the wireless earpieces 102 to maximize the battery life based on motion, lighting conditions, and other factors established for the user. For example, the user 106 may set the wireless earpieces 102 to enter a full power mode only if positioned within the ears of the user 106 within ten seconds of being moved, otherwise the wireless earpieces 102 remain in a low power mode to preserve battery life. This setting may be particularly useful if the wireless earpieces 102 are periodically moved or jostled without being inserted into the ears of the user 106.

The user 106 or another party may also utilize the wireless device 104 to associate user information and conditions with the user preferences. For example, an application executed by the wireless device 104 may be utilized to specify the conditions (e.g., user biometrics read by the sensors 112) may “wake up” the wireless earpieces 102 to automatically or manually communicate information, warnings, data, or status information to the user. In addition, the enabled functions or components (e.g., sensors, transceivers, vibration alerts, speakers, lights, etc.) may be selectively activated based on the user preferences as set by default, by the user, or based on historical information. In another embodiment, the wireless earpieces 102 may be adjusted or trained over time to become even more accurate in adjusting to habits, requirements, requests, activations, or other processes or functions performed by the wireless earpieces 102 for the user (e.g., applications, virtual assistants, etc.). The wireless earpieces 102 may utilize historical information to generate default values, baselines, thresholds, policies, or settings for determining when and how various communications, actions, and processes are implemented. As a result, the wireless earpieces 102 may effectively manage the automatic and manually performed processes of the wireless earpieces 102 based on automatic detection of events and conditions (e.g., light, motion, user sensor readings, etc.) and user specified settings.

As previously noted, the wireless earpieces 102 may include any number of sensors 112 and logic for measuring and determining user biometrics, such as pulse rate, skin conduction, blood oxygenation, blood pressure, heart rate variability, blood velocity, temperature, calories expended, blood or excretion chemistry, voice and audio output, position, and orientation (e.g., body, head, etc.). The sensors 112 may also determine the user's location, position, velocity, impact levels, and so forth. Any of the sensors 112 may be utilized to detect or confirm light, motion, or other parameters affecting how the wireless earpieces 102 manage, utilize, and initialize the virtual assistant. The sensors 112 may also receive user input and convert the user input into commands or selections made across the personal devices of the personal area network. For example, the user input detected by the wireless earpieces 102 may include voice commands, head motions, finger taps, finger swipes, motions or gestures, or other user inputs sensed by the wireless earpieces. The user input may be determined by the wireless earpieces 102 and converted into authorization commands sent to one or more external devices, such as the wireless device 104, the personal computer 118, a tablet computer, or so forth. For example, the user 106 may create a specific head motion and voice command when detected by the wireless earpieces 102 utilized to send a request to the virtual assistant (implemented by the wireless earpiece or wireless earpieces 102/wireless device 104) to tell the user 106 her current heart rate, speed, and location. In another example, the sensors 112 may prepare the wireless earpieces for an impact in response to determining the wireless earpieces 102 are free falling or have been dropped (e.g., device power down, actuator compression/shielding of sensitive components, etc.).

The sensors 112 may make all the measurements regarding the user 106 and communications environment 100 or may communicate with any number of other sensory devices, components, or systems in the communications environment 100. In one embodiment, the communications environment 100 may represent all or a portion of a personal area network. The wireless earpieces 102 may be utilized to control, communicate, manage, or interact with several other wearable devices or electronics, such as smart glasses, helmets, smart glass, watches or wrist bands, other wireless earpieces, chest straps, implants, displays, clothing, or so forth. A personal area network is a network for data transmissions among devices, components, equipment, and systems, such as personal computers, communications devices, cameras, vehicles, entertainment/media devices, and medical devices. The personal area network may utilize any number of wired, wireless, or hybrid configurations and may be stationary or dynamic. For example, the personal area network may utilize wireless network protocols or standards, such as INSTEON, IrDA, Wireless USB, Bluetooth, Z-Wave, ZigBee, Wi-Fi, ANT+ or other applicable radio frequency signals. In one embodiment, the personal area network may move with the user 106.

In other embodiments, the communications environment 100 may include any number of devices, components, or so forth communicating with each other directly or indirectly through a wireless (or wired) connection, signal, or link. The communications environment 100 may include one or more networks and network components and devices represented by the network 120, such as routers, servers, signal extenders, intelligent network devices, computing devices, or so forth. In one embodiment, the network 120 of the communications environment 100 represents a personal area network as previously disclosed.

Communications within the communications environment 100 may occur through the network 120 or may occur directly between devices, such as the wireless earpieces 102 and the wireless device 104. The network 120 may communicate with or include a wireless network, such as a Wi-Fi, cellular (e.g., 3G, 4G, 5G, PCS, GSM, etc.), Bluetooth, or other short-range or long-range radio frequency networks, signals, connections, or links. The network 120 may also include or communicate with any number of hard wired networks, such as local area networks, coaxial networks, fiber-optic networks, network adapters, or so forth. Communications within the communications environment 100 may be operated by one or more users, service providers, or network providers.

The wireless earpieces 102 may play, display, communicate, or utilize any number of alerts or communications to indicate the actions, activities, communications, mode, or status in use or being implemented. For example, one or more alerts may indicate when various processes are implemented automatically or manually selected by the user. The alerts may indicate when actions are in process, authorized, and/or changing with specific tones, verbal acknowledgements, tactile feedback, or other forms of communicated messages. For example, an audible alert and LED flash may be utilized each time the wireless earpieces 102 receive user input. Verbal or audio acknowledgements, answers, and actions utilized by the wireless earpieces 102 are effective because of user familiarity with such devices in standard smart phone and personal computers. The corresponding alert may also be communicated to the user 106, the wireless device 104, and the personal computer 118.

In other embodiments, the wireless earpieces 102 may also vibrate, flash, play a tone or other sound, or give other indications of the actions, status, or process of the virtual assistant. The wireless earpieces 102 may also communicate an alert to the wireless device 104 showing up as a notification, message, or other indicator indicating changes in status, actions, commands, or so forth.

The wireless earpieces 102 as well as the wireless device 104 may include logic for automatically implementing the virtual assistant in response to motion, light, user activities, user biometric status, user location, user position, historical activity/requests, or various other conditions and factors of the communications environment 100. The virtual assistant may be activated to perform a specified activity or to “listen” or be prepared to “receive” user input, feedback, or commands for implementation by the virtual assistant.

The wireless device 104 may represent any number of wireless or wired electronic communications or computing devices, such as smart phones, laptops, desktop computers, control systems, tablets, displays, gaming devices, music players, personal digital assistants, vehicle systems, or so forth. The wireless device 104 may communicate utilizing any number of wireless connections, standards, or protocols (e.g., near field communications, NFMI, Bluetooth, Wi-Fi, wireless Ethernet, etc.). For example, the wireless device 104 may be a touch screen cellular phone communicating with the wireless earpieces 102 utilizing Bluetooth communications. The wireless device 104 may implement and utilize any number of operating systems, kernels, instructions, or applications making use of the available sensor data sent from the wireless earpieces 102. For example, the wireless device 104 may represent any number of android, iOS, Windows, open platforms, or other systems and devices. Similarly, the wireless device 104 or the wireless earpieces 102 may execute any number of applications utilizing the user input, proximity data, biometric data, and other feedback from the wireless earpieces 102 to initiate, authorize, or process virtual assistant processes and perform the associated tasks.

As noted, the layout of the internal components of the wireless earpieces 102 and the limited space available for a product of limited size may affect where the sensors 112 may be positioned. The positions of the sensors 112 within each of the wireless earpieces 102 may vary based on the model, version, and iteration of the wireless earpiece design and manufacturing process.

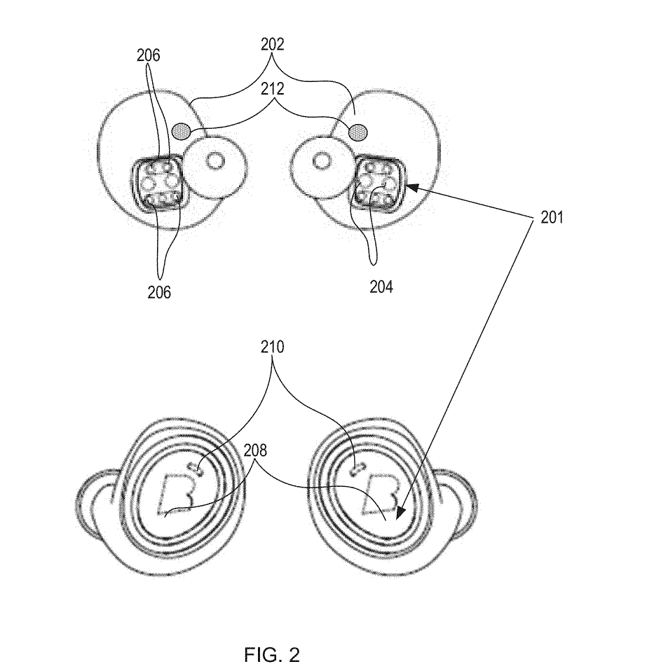

FIG. 2 is a pictorial representation of some of the sensors 201 of wireless earpieces 202 in accordance with illustrative embodiments. As previously noted, the wireless earpieces 202 may include any number of internal or external sensors. In one embodiment, the sensors 201 may be utilized to determine user biometrics, environmental information associated with the wireless earpieces 202, and use the status of the wireless earpieces 202. Similarly, any number of other components or features of the wireless earpieces 202 may be managed based on the measurements made by the sensors 201 to preserve resources (e.g., battery life, processing power, etc.). The sensors 201 may make independent measurements or combined measurements utilizing the sensory functionality of each of the sensors 201 to measure, confirm, or verify sensor measurements. For example, the wireless earpieces 202 may represent a set or pair of wireless earpieces or the left wireless earpiece and the right wireless earpiece may operate independent of each other as situations may require.

In one embodiment, the sensors 201 may include optical sensors 204, contact sensors 206, infrared sensors 208, microphones 210, and radar sensors 212. The optical sensors 204 may generate an optical signal communicated to the ear (or other body part) of the user and reflected. The reflected optical signal may be analyzed to determine blood pressure, pulse rate, pulse oximetry, vibrations, blood chemistry, and other information about the user. The optical sensors 204 may include any number of sources for outputting various wavelengths of electromagnetic radiation (e.g., infrared, laser, etc.) and visible light. Thus, the wireless earpieces 202 may utilize spectroscopy as it is known in the art to determine any number of user biometrics.

The optical sensors 204 may also be configured to detect ambient light proximate the wireless earpieces 202. For example, the optical sensors 204 may detect light and light changes in an environment of the wireless earpieces 202, such as in a room where the wireless earpieces 202 are located (utilizing optical sensors 204 internally and externally positioned regarding the body of the user). The optical sensors 204 may be configured to detect any number of wavelengths including visible light relevant to light changes, approaching users or devices, and so forth.

In another embodiment, the contact sensors 206 may be utilized to determine the wireless earpieces 202 are positioned within the ears of the user. For example, conductivity of skin or tissue within the user's ear may be utilized to determine whether the wireless earpieces are being worn. In other embodiments, the contact sensors 206 may include pressure switches, toggles, or other mechanical detection components for determining whether the wireless earpieces 202 are being worn. The contact sensors 206 may measure or provide additional data points and analysis indicating the biometric information of the user. The contact sensors 206 may also be utilized to apply electrical, vibrational, motion, or other input, impulses, or signals to the skin of the user to detect utilization or positioning.

The wireless earpieces 202 may also include infrared sensors 208. The infrared sensors 208 may be utilized to detect touch, contact, gestures, or another user input. The infrared sensors 208 may detect infrared wavelengths and signals. In another embodiment, the infrared sensors 208 may detect visible light or other wavelengths as well. The infrared sensors 208 may be configured to detect light or motion or changes in light or motion. Readings from the infrared sensors 208 and the optical sensors 204 may be configured to detect light or motion. The readings may be compared to verify or otherwise confirm light or motion. As a result, virtual assistant decisions regarding user input, biometric readings, environmental feedback, and other measurements may be effectively implemented in accordance with readings from the sensors 201 as well as other internal or external sensors and the user preferences. The infrared sensors 208 may also include touch sensors integrated with or proximate the infrared sensors 208 externally available to the user when the wireless earpieces 202 are worn by the user.

The wireless earpieces 202 may include microphones 210. The microphones 210 may represent external microphones as well as internal microphones. The external microphones may be positioned exterior to the body of the user as worn. The external microphones may sense verbal or audio input, feedback, and commands received from the user. The external microphones may also sense environmental, activity, additional users (e.g., clients, jury members, judges, attorneys, paramedics, etc.), and external noises and sounds. The internal microphone may represent an ear-bone or bone-conduction microphone. The internal microphone may sense vibrations, waves, or sound communicated through the bones and tissue of the user's body (e.g., skull). The microphones 210 may sense input, feedback, and content utilized by the wireless earpieces 202 to implement the processes, functions, and methods herein described. The audio input sensed by the microphones 210 may be filtered, amplified, or otherwise processed before or after being sent to the processor/logic of the wireless earpieces 202.

In one embodiment, the wireless earpieces 202 may include the radar sensors 212. The radar sensor 212 may include or utilize pulse radar, continuous wave radar, active, passive, laser, ambient electromagnetic field, or radio frequency radiation or signals or any number of other radar methodologies, systems, processes, or components. In one embodiment, the radar sensors 212 may utilize ultrasonic pulse probes relying on the Doppler effect or ultra-wide band sensing to detect the relative motion of blow flow of the user from the wireless earpieces 202. In one embodiment, the physiological measurements performed by the radar sensors 212 may be limited to the ear of the user. In another embodiment, the radar sensors 212 may be able to measure other biometrics, such as heart motion, respiration, and so forth. For example, the radar sensors 212 may include a radar seismocardiogram (R-SCG) utilizing radio frequency integrated circuits with the wireless earpieces 202 to measure user biometrics with small, low-power radar units. The radar sensors 212 may also be utilized to biometrically identify the user utilizing the structure, reflective properties, or configuration of the user's ear, head, and/or body (like utilization of fingerprints). For example, the radar sensors 212 may perform analysis to determine whether the user is an authorized or verified user.

In one embodiment, the radar sensor 212 may include one or more of a synchronizer, modulator, transmitter, duplexer, and receiver. The transmitter and receiver may be at the same location (monostatic radar) within the wireless earpieces 202 or may be integrated at different locations (bistatic radar). The radar sensor 212 may be configured to utilize different carrier, pulse widths, pulse repetition frequencies, polarizations, filtering (e.g., matched filtering, clutter, signal-to-noise ratio), or so forth. In one embodiment, the radar sensor 212 is an integrated circuit or chip performing Doppler based measurements of blood flow.

The illustrative embodiments may include some or all the sensors 201 described herein. In one embodiment, the wireless earpieces 102 may include the radar sensors 212 without the optical sensors 204 and infrared sensors 208. In one embodiment, the radar sensors 212 may utilize the signals from transceivers already integrated into the wireless earpieces 102 to generate a signal and receive the corresponding reflection. The radar sensors 212 may also represent sonar or ultrasound sensors.

In another embodiment, the wireless earpieces 202 may include chemical sensors (not shown) performing chemical analysis of the user's skin, excretions, blood, or any number of internal or external tissues or samples. For example, the chemical sensors may determine whether the wireless earpieces 202 are being worn by the user. The chemical sensor may also be utilized to monitor important biometrics more effectively read utilizing chemical samples (e.g., sweat, blood, excretions, etc.). In one embodiment, the chemical sensors are non-invasive and may only perform chemical measurements and analysis based on the externally measured and detected factors. In other embodiments, one or more probes, vacuums, capillary action components, needles, or other micro-sampling components may be utilized. Minute amounts of blood or fluid may be analyzed to perform chemical analysis reported to the user and others. The sensors 201 may include parts or components periodically replaced or repaired to ensure accurate measurements. In one embodiment, the infrared sensors 208 may be a first sensor array and the optical sensors 204 may be a second sensor array.

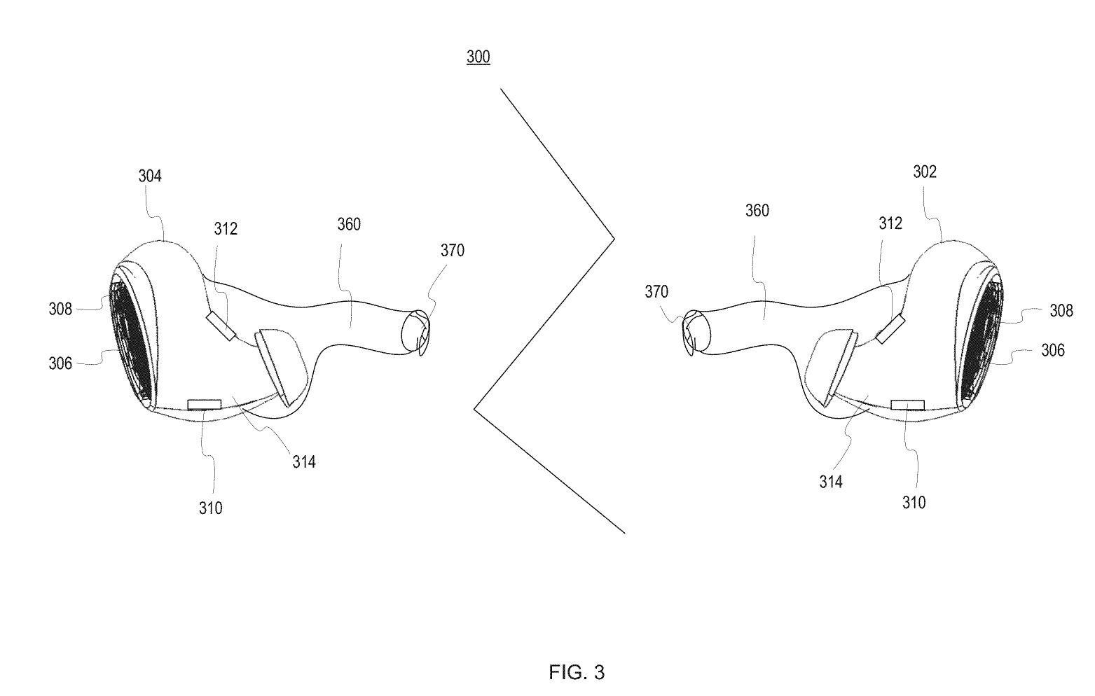

FIG. 3 is a pictorial representation of a right wireless earpiece 302 and a left wireless earpiece 304 of a wireless earpiece set 300 in accordance with an illustrative embodiment. For example, the right wireless earpiece 302 is shown as it relates to a user's or third party's right ear and the left wireless earpiece 304 is shown as it relates to a user's or third party's left ear. The user or third party may interact with the right wireless earpiece 302 or the left wireless earpiece 304 by either providing a gesture sensed by a gesture interface 306, a voice command sensed via a microphone 308, or by one or more head or neck motions which may be sensed by an inertial sensor such as a MEMS gyroscope, magnetometer, or an electronic accelerometer. In one embodiment, the gesture interface 306 may include one or more optical sensors, touch/capacitive sensors, or so forth. The microphone 308 may represent one or more over-air or bone conduction microphones. The air-based microphone may be positioned on an exterior of the right wireless earpiece 302 and left wireless earpiece 304 when worn by the user. The bone conduction microphone may be positioned on an interior portion of the right wireless earpiece 302 or the left wireless earpiece 304 to abut the skin, tissues, and bones of the user.

The wireless earpiece set 300 may include one or more radar sensors for each of the right wireless earpiece and the left wireless earpiece. In one embodiment (not shown), the right wireless earpiece 302 and the left wireless earpiece 304 may each include a single radar unit. As shown, the right wireless earpiece 302 and the left wireless earpiece 304 may each include a first radar unit 310 and a second radar unit 312. In one embodiment, the first radar unit 310 and the second radar unit 312 may be completely enclosed within a housing 314 of the right wireless earpiece 302 and the left wireless earpiece 304. In another embodiment, the first radar unit 310 and the second radar unit 312 may be positioned flush with an outer edge of the housing 314. In yet another embodiment, the first radar unit 310 and the second radar unit 312 may protrude slightly from an outer edge of the housing 314.

In one embodiment, the first radar unit 310 and the second radar unit 312 may be positioned adjacent or proximate each other within each of the wireless earpieces 304, 302. For example, the first radar unit 310 may transmit a signal and the second radar unit 312 may detect the reflections of the signal sent from the first radar unit 310. The right wireless earpiece 302 and the left wireless earpiece 304 may perform separate measurements. The results corresponding to heart rate variability or so forth may be processed, recorded, displayed, logged, or communicated separately or jointly based on the application, user preferences, and so forth. For example, biometric results may be averaged between measurements made by the first radar unit 310 and second radar unit 312 of the set of wireless earpieces 300.

In another embodiment, the first radar unit 310 and the second radar unit 312 may be positioned separately. For example, the first radar unit 310 may broadcast a signal and the second radar unit 312 may receive the reflections. Different transmitting and separating components and positions may enhance effectiveness of the radar while reducing noise and processing difficulties.

In other embodiments, the first radar unit 310 and the second radar unit 312 may represent distinct radar units utilizing distinct signals and target body areas. For example, the first radar unit 310 and the second radar unit 312 may be pointed toward different portions of the ear of the user. For example, the frequency of the signals may be varied as needed to best detect the applicable user biometric or environmental condition. The first and second radar units 310 and 312 may vary the frequency dynamically, based on user input, or so forth.

For example, if a third party wearing the right wireless earpiece 302 receives an invitation to establish a connection from the user 106 (or another third party), which may already be established between the user 106 and one or more third parties, the third party receiving the invitation may accept the invitation by nodding his head, which may be sensed by the inertial sensor 34 such as an electronic accelerometer via voltage changes due to capacitance differentials caused by the nodding of the head. In addition, the third party may tap on or swipe across the gesture interface 306 to bring up a menu in which to send, for example, a preprogrammed reply or one or more pieces of media the third party wishes to share with the user and/or one or more other third parties currently connected to the third party.

The left and right wireless earpiece 302 and 304 may be positioned within the ear canal 360 to minimize the distance between the right wireless earpiece 302 and the user's tympanic membrane 370 so any sound communications received by the third party are effectively communicated to the third party using the right wireless earpiece 302.

In another embodiment, externally facing radar may be integrated with the gesture interface 306. The gesture interface 306 may include one or more radar units including LIDAR, RF radar, or so forth. The radar units in the gesture interface 306 may be utilized to sense user input or feedback, such as head motions, hand gestures, or so forth. In another embodiment, the radar units in the gesture interface may sense proximity to other people, vehicles, structures, or so forth. For example, the radar units may detect a vehicle or object may strike the user from the side (e.g., a blind spot) and may give warnings or alerts (e.g., verbal alert—look to your left, watch out, beeps in the left wireless earpiece 304, etc.).

FIG. 4 is a block diagram of wireless earpieces 400 in accordance with an illustrative embodiment. The description of the components, structure, functions, and other elements of the wireless earpieces 400 may refer to a left wireless earpiece 304, a right wireless earpiece 302, or both wireless earpieces 400 as a set or pair. All or a portion of the components shown for the wireless earpieces 400 may be included in each of the wireless earpieces. For example, some components may be included in the left wireless earpiece 304, but not the right wireless earpiece 302 and vice versa. In another example, the wireless earpieces 400 may not include all the components described herein for increased space for batteries or so forth.

The wireless earpieces 400 are an embodiment of wireless earpieces, such as those shown in FIGS. 1-3 (e.g., wireless earpieces 102, 202, 302, 304). The wireless earpieces may include one or more light emitting diodes (LEDs) 402 electrically connected to a processor 404 or other intelligent control system. The wireless earpieces 400 may represent ear buds, on-ear headphones, or over-ear headphones. In one embodiment, the wireless earpieces 400 may represent wireless earpieces as shown in FIGS. 1-3 in addition to a set of over ear wireless earpieces worn by the user. They may be used jointly or separately.

The processor 404 is the logic controls for the operation and functionality of the wireless earpieces 400. The processor 404 may include circuitry, chips, and other digital logic. The processor 404 may also include programs, scripts, and methods implemented to operate the various components of the wireless earpieces 400. The processor 404 may represent hardware, software, firmware, or any combination thereof. In one embodiment, the processor 404 may include one or more processors or processors. For example, the processor 404 may represent an application specific integrated circuit (ASIC) or field programmable gate array (FPGA). The processor 404 may utilize information from the sensors 406 to determine the biometric information, data, and readings of the user. The processor 404 may utilize this information and other criteria to inform the user of the biometrics (e.g., audibly, through an application of a connected device, tactilely, etc.) as well as communicate with other electronic devices wirelessly through the transceivers 450, 452, 454.

The processor 404 may also process user input to determine commands implemented by the wireless earpieces 400 or sent for processing through the transceivers 450, 452, 454. Specific actions may be associated with biometric data thresholds. For example, the processor 404 may implement a macro allowing the user to associate biometric data as sensed by the sensors 406 with specified commands, alerts, and so forth. For example, if the temperature of the user is above or below high and low thresholds, an audible alert may be played to the user and a communication sent to an associated medical device for communication to one or more medical professionals. In one embodiment, the processor 404 may process radar data to identify user biometrics (e.g. blood pressure, heart rate variability, blood velocity, head structure, etc.), external conditions (e.g., approaching objects, user proximity to structures, people, objects, etc.), and other applicable information.

A memory 405 is a hardware element, device, or recording media configured to store data or instructions for subsequent retrieval or access later. The memory 405 may represent static or dynamic memory. The memory 405 may include a hard disk, random access memory, cache, removable media drive, mass storage, or configuration suitable as storage for data, instructions, and information. In one embodiment, the memory 405 and the processor 404 may be integrated. The memory may use any type of volatile or non-volatile storage techniques and mediums. The memory 405 may store information related to the status of a user, wireless earpieces 400, interconnected electronic device, and other peripherals, such as a wireless device, smart glasses, smart watch, smart case for the wireless earpieces 400, wearable device, and so forth. In one embodiment, the memory 405 may display instructions, programs, drivers, or an operating system for controlling the user interface including one or more LEDs or other light emitting components, speakers, tactile generators (e.g., vibrator), and so forth. The memory 405 may also store the thresholds, conditions, or biometric data (e.g., biometric and data library) associated with biometric events.

The processor 404 may also be electrically connected to one or more sensors 406. In one embodiment, the sensors 406 may include inertial sensors 408, 410 or other sensors measuring acceleration, angular rates of change, velocity, and so forth. For example, each inertial sensor 408, 410 may include an accelerometer, a gyro sensor or gyrometer, a magnetometer, a potentiometer, or other type of inertial sensor.

The sensors 406 may also include one or more contact sensors 412, one or more bone conduction microphones 414, one or more air conduction microphones 416, one or more chemical sensors 418, a pulse oximeter 418, a temperature sensor 420, or other physiological or biological sensors 422. Further examples of physiological or biological sensors 422 include an alcohol sensor 424, glucose sensor 426, or bilirubin sensor 428. Other examples of physiological or biological sensors 422 included in the wireless earpieces 402 include a blood pressure sensor 430, an electroencephalogram (EEG) 432, an Adenosine Triphosphate (ATP) sensor 434, a lactic acid sensor 436, a hemoglobin sensor 438, a hematocrit sensor 440, or other biological or chemical sensor.

In one embodiment, the wireless earpieces 400 may include radar sensors 429. As described herein, the radar sensors 429 may be positioned to look toward the user wearing the wireless earpieces 400, to provide biometric and/or user identification data, or external to the wireless earpieces 400 to provide contextual awareness information. The radar sensors 429 may be configured to perform analysis or may capture information, data, and readings in the form of reflected signals processed by the processor 404. The radar sensors 429 may include Doppler radio, laser/optical radar, or so forth. The radar sensors 429 may be configured to perform measurements regardless of whether the wireless earpieces 400 are being worn or not. In one embodiment, the wireless earpieces 400 may include a modular radar unit added to or removed from the wireless earpieces 400. In other embodiments, a modular sensor unit may include the sensors 406 and may be removed, replaced, exchanged, or so forth. The modular sensor unit may allow the wireless earpieces 400 to be adapted for specific purposes, functionality, or needs. For example, the modular sensor unit may have contacts for interfacing with the other portions of the components. The modular sensor unit may have an exterior surface contacting the ear skin or tissue of the user for performing direct measurements.

The radar sensors 429 may determine the orientation and motion of the wireless earpieces 400 regarding one another as well as the user's head. The radar sensors 429 may also determine the distance between the wireless earpieces 400. The radar sensors 429 may also identify a user utilizing the wireless earpieces 400 to determine whether it is an authorized/registered user or a guest, unauthorized user, or other party. The radar signature for each user may vary based on the user's ear, head, and body shape and may be utilized to perform verification and identification.

The radar sensors 429 can be adapted to provide contextual awareness for user 106. Contextual awareness can be additional data of the user's surroundings, which can provide much needed and necessary information. Radar sensors 429 can provide this information either in part of in whole. Utilizing externally facing radar sensor(s) 429 user 106 can collect object avoidance data. Radar sensor(s) 429 could relay to processor 404 information related to detected objects and pass this information on to user 106 through audio or tacitly. Radar sensor(s) 429 could also be used to assist with impact alerts. If radar sensor(s) 429 detect an object closing quickly on user 106, processor 404 can notify user 106 to brace for impact and/or confirm with other sensor readings of the impending impact and notify the user if it is determined an impact is imminent.

Radar sensors 429 can also provide navigation assistance. If user 106 is utilizing a navigation program with wireless earpieces 400, an externally facing radar sensor(s) 429 could provide user 106 with verification of detected landmarks and any obstacles which may be in the user's way. A user 106 can also use radar sensor(s) 429 to map the surroundings of a user. For example, if a user 106 would like to map a room out, then processor 404 could use radar sensor(s) 429 to collect data as the user 106 walked around a room. Processor 404 would collect the data provided by radar sensor(s) 429 and create a map of the room with highly accurate dimensions and objects within the room. This feature could be especially helpful in military applications as radar sensor(s) 429 could provide additional information to nighttime vision goggles as they can pick up and provide information about the user's periphery. This could essentially give a user a full 360° picture of their surroundings. Further, radar sensor(s) 429 could perform as motion detection devices as they can detect movement relative to the user and provide this information to processor 404. Processor 404 can then consider the user's own movement and the movement of the detected object by radar sensor(s) 429 and decide to inform the user of the object or not as closing and/or moving away.

A user 106 could also user radar sensor(s) 429 for object tracking. Through gesture control interface a user 106 could instruct processor 404 to identify and track and object through radar sensor(s) 429. Once again, this could be useful for military applications where an operator needs to be aware of a secondary targets movement who may be behind or in the periphery of the user 106. A mother could use this feature to help keep track of her children where a notification would be sent to the user 106 if a child went out of the radar sensor(s) 429 range or detection.

A spectrometer 442 is also shown. The spectrometer 442 may be an infrared (IR) through ultraviolet (UV) spectrometer although it is contemplated any number of wavelengths in the infrared, visible, or ultraviolet spectrums may be detected (e.g., X-ray, gamma, millimeter waves, microwaves, radio, etc.). In one embodiment, the spectrometer 442 is adapted to measure environmental wavelengths for analysis and recommendations, and thus, may be located or positioned on or at the external facing side of the wireless earpieces 400.

A gesture control interface 444 is also operatively connected to the processor 404. The gesture control interface 444 may include one or more emitters 446 and one or more detectors 448 for sensing user gestures. The emitters 446 may be of any number of types including infrared LEDs, lasers, and visible light.

The wireless earpieces may also include several transceivers 450, 452, 454. The transceivers 450, 452, 454 are components including both a transmitter and receiver which may be combined and share common circuitry on a single housing. The transceivers 450, 452, 454 may communicate utilizing Bluetooth, Wi-Fi, ZigBee, Ant+, near field communications, wireless USB, infrared, mobile body area networks, ultra-wideband communications, cellular (e.g., 3G, 4G, 5G, PCS, GSM, etc.), infrared, or other suitable radio frequency standards, networks, protocols, or communications. The transceivers 450, 452, 454 may also be a hybrid transceiver supporting several different communications. For example, the transceiver 450, 452, 454 may communicate with other electronic devices or other systems utilizing wired interfaces (e.g., wires, traces, etc.), NFC or Bluetooth communications. For example, a transceiver 450 may allow for induction transmissions such as through near field magnetic induction (NFMI).

Another transceiver 452 may utilize any number of short-range communications signals, standards or protocols (e.g., Bluetooth, BLE, UWB, etc.), or other form of radio communication operatively connected to the processor 404. The transceiver 452 may be utilized to communicate with any number of communications, computing, or network devices, systems, equipment, or components. The transceiver 452 may also include one or more antennas for sending and receiving signals.

In one embodiment, the transceiver 454 may be a magnetic induction electric conduction electromagnetic (E/M) transceiver or other type of electromagnetic field receiver or magnetic induction transceiver operatively connected to the processor 404 to link the processor 404 to the electromagnetic field of the user. For example, the use of the transceiver 454 allows the device to link electromagnetically into a personal area network, body area network, or other device.

In operation, the processor 404 may be configured to convey different information using one or more of the LEDs 402 based on context or mode of operation of the device. The various sensors 406, the processor 404, and other electronic components may be located on the printed circuit board of the device. One or more speakers 454 may also be operatively connected to the processor 404.

The wireless earpieces 400 may include a battery 456 powering the various components to perform the processes, steps, and functions herein described. The battery 456 is one or more power storage devices configured to power the wireless earpieces 400. In other embodiments, the battery 208 may represent a fuel cell, thermal electric generator, piezo electric charger, solar charger, ultra-capacitor, or other existing or developing power storage technologies.

Although the wireless earpieces 400 shown includes numerous different types of sensors and features, it is to be understood each wireless earpiece need only include a basic subset of this functionality. It is further contemplated sensed data may be used in various ways depending upon the type of data being sensed and the application(s) of the earpieces.

As shown, the wireless earpieces 400 may be wirelessly linked to any number of wireless or computing devices (including other wireless earpieces) utilizing the transceivers 450, 452, 454. Data, user input, feedback, and commands may be received from either the wireless earpieces 400 or the computing device for implementation on either of the devices of the wireless earpieces 400 (or other externally connected devices). As previously noted, the wireless earpieces 400 may be referred to or described herein as a pair (wireless earpieces) or singularly (wireless earpiece). The description may also refer to components and functionality of each of the wireless earpieces 202 collectively or individually.

In some embodiments, linked or interconnected devices may act as a logging tool for receiving information, data, or measurements made by the wireless earpieces 400. For example, a linked computing device may download data from the wireless earpieces 400 in real-time. As a result, the computing device may be utilized to store, display, and synchronize data for the wireless earpieces 400. For example, the computing device may display pulse rate, blood oxygenation, blood pressure, temperature, and so forth as measured by the wireless earpieces 400. In this example, the computing device may be configured to receive, and display alerts indicating a specific health event or condition has been met. For example, if the forces applied to the sensors 406 (e.g., accelerometers) indicates the user may have experienced a concussion or serious trauma, the wireless earpieces 400 may generate and send a message to the computing device. The wireless earpieces 400 may have any number of electrical configurations, shapes, and colors and may include various circuitry, connections, and other components.

The components of the wireless earpieces 400 may be electrically connected utilizing any number of wires, contact points, leads, busses, wireless interfaces, or so forth. In addition, the wireless earpieces 400 may include any number of computing and communications components, devices or elements which may include busses, motherboards, circuits, chips, sensors, ports, interfaces, cards, converters, adapters, connections, transceivers, displays, antennas, and other similar components.

The wireless earpieces 400 may also include physical interfaces (not shown) for connecting the wireless earpieces with other electronic devices, components, or systems, such as a smart case or wireless device. The physical interfaces may include any number of contacts, pins, arms, or connectors for electrically interfacing with the contacts or other interface components of external devices or other charging or synchronization devices. For example, the physical interface may be a micro USB port. In one embodiment, the physical interface is a magnetic interface automatically coupling to contacts or an interface of the computing device. In another embodiment, the physical interface may include a wireless inductor for charging the wireless earpieces 400 without a physical connection to a charging device.

As originally packaged, the wireless earpieces 400 may include peripheral devices such as charging cords, power adapters, inductive charging adapters, solar cells, batteries, lanyards, additional light arrays, speakers, smart case covers, transceivers (e.g., Wi-Fi, cellular, etc.), or so forth.

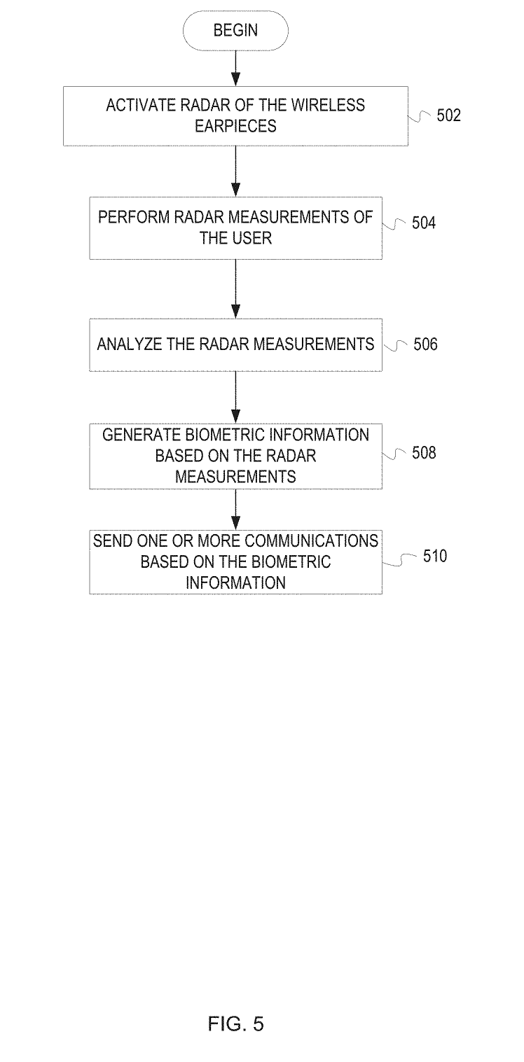

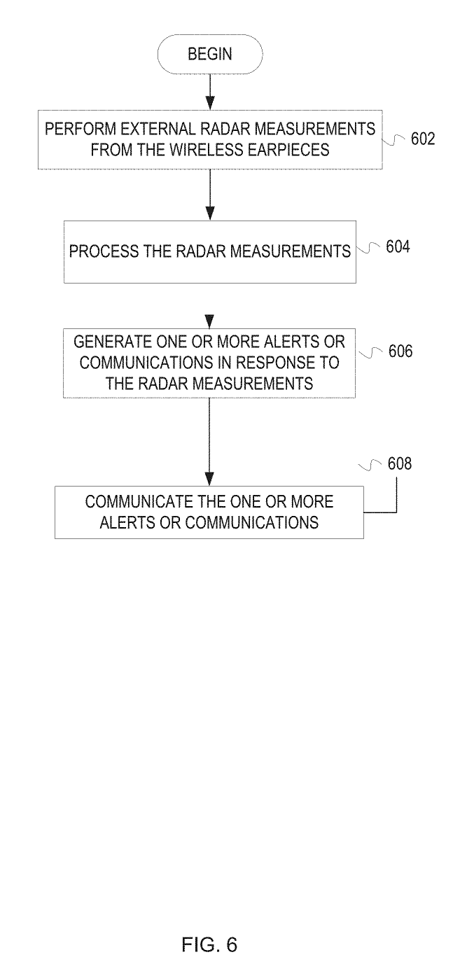

FIG. 5 is a flowchart of a process for performing radar measurements of a user utilizing wireless earpieces in accordance with illustrative embodiments. In one embodiment, the process of FIGS. 5 and 6 may be implemented by one or more wireless earpieces worn by a user (e.g., wireless earbuds, over-ear headphones, on-ear headphones, etc.). In another embodiment, the wireless earpieces need not be worn to be utilized.

In one embodiment, the process begins by activating radar of the wireless earpieces (step 502). The radar may represent Doppler or optical radar utilizing any number of signals (e.g., pulse, continuous, etc.). In one embodiment, the radar sensors or units of the wireless earpieces may be activated whenever the wireless earpieces are turned on (e.g., not in a power save, low power, or charging mode). In other embodiments, a specific function, application, user request, or other automated or manual process may initiate, power-on, or otherwise activate the radar of the wireless earpieces. In one embodiment, the radar sensors of the wireless earpieces worn in-ear may be positioned within the external auditory canal. In another embodiment, the radar sensors of the wireless earpieces may be integrated in headphones worn by the user and may read measurements from the user's ear, neck, head, or other portions of the body of the user.

Next, the wireless earpieces perform radar measurements of the user (step 504). Each of the wireless earpieces may include one or more radar sensors or units performing radar measurements. In one embodiment, each radar unit may send a signal and receive back the reflections. In another embodiment, distinct radar units (whether within a single wireless earpiece or utilized between the different wireless earpieces) may send radar signals and receive the reflections or echoes. In one embodiment, the radar sensors may be directed toward one or more different portions of the user's ear, head, or body.

Next, the wireless earpieces analyze the radar measurements (step 506). The radar measurements may be analyzed or otherwise processed by a processor or processor. The measurement parameters may include motion, such as rotation, displacement, deformation, acceleration, fluid-flow velocity, vortex shedding Poiseulle's law of fluid flow, Navier Stoke's equations, and so forth. For example, the radar sensors may measure the displacement of vessel walls. The radar sensors may measure the movement and volume of the residual component of the external auditory canal. The measurements may be detected in the received signal. The radar measurements may be converted to data, information, values, graphics, charts, visuals, or other information communicated audibly through the wireless earpieces to a communications or computing devices. For example, biometric information, values, and data retrieved through analysis may be communicated to the user. During step 506, the radar sensors may detect changes in the received/reflected signal to determine amplitude, phase, phase angle and other applicable information (e.g., backscatter analysis). The analysis may determine the position, location, and orientation of the user and the wireless earpieces relative to each other and the user.

Next, the wireless earpieces generate biometric information based on the radar measurements (step 508). The biometric information may be generated from each of the wireless earpieces or may represent combined measurements from multiple wireless earpieces including one or more radar sensors/units. The biometric information may include heart rate, heart rate variability, blood flow velocity, blood oxygenation, blood pressure, stridor level, cerebral edema, respiration rate, excretion levels, ear/face/body structure, and other user biometrics. For example, the radar sensors may detect any number of biometrics or conditions associated with blood flow or changes in blood flow. The wireless earpieces may utilize any number of mathematical, signal processing, filtering, or other processes to generate the biometric information. The radar sensors may be utilized in conjunction with accelerometers, gyroscopes, thermistors, optical sensors, magnetometers, pressure sensors, environmental sensors, microphones, and so forth.

Next, the wireless earpieces send one or more communications based on the biometric information (step 510). The wireless earpieces may communicate the biometric information utilizing audible notices (e.g., your heart rate variability is ______, your blood pressure is ______, etc.), sounds, alerts, tactile feedback, light emissions (e.g., LEDs, touch screens, etc.).

FIG. 6 is a flowchart of a process for generating alerts in response to external radar measurements performed by the wireless earpieces. In one embodiment, the process of FIG. 6 may be implemented utilizing one or more externally facing radar sensors/units within the wireless earpieces. For example, the touch/gesture interface may include Doppler radar sensors, LIDAR, or other similar radar units. All or portions of the processes described in FIGS. 5 and 6 (as well as the other included Figures and description) may be combined in any order, step, or any potential iteration.

The process of FIG. 6 may begin by performing external radar measurements from the wireless earpieces (step 602). As previously described, the wireless earpieces may each include one or more internal and externally facing radar sensors. The radar sensors may be utilized to protect the user and document incoming people or objects as well as associated events, such as wrecks, crashes, collisions, contact, proximity alerts, near misses, and so forth. The external radar sensors may be fixedly positioned or may dynamically move toward a specific direction utilizing any number of motors, actuators, and so forth.

Next, the wireless earpieces process the radar measurements (step 604). In one embodiment, the wireless earpieces may utilize internal processors, logic, circuits, or so forth to process the radar measurements. The radar sensors/units may also be configured to dynamically adjust signals based on the conditions, user, environment, noise levels, and so forth and to correspondingly process the radar measurements. During step 604, the radar measurements may be processed for communication or display by the wireless earpieces or any number of other devices in communication with the wireless earpieces.

During step 604, the wireless earpieces may determine whether there is a condition or event which should be communicated to the user/connected device, logged, recorded, or streamed, or otherwise processed. In one embodiment, user preferences, settings, parameters, thresholds, conditions, or other information may be utilized to determine whether an action should be performed. For example, the radar sensors may determine the user may have fallen based on the detected motion of the user's head, a user is about to be struck by a vehicle (e.g., car, bicycle, etc.), the user is proximate a wall or other object, or any number of other activities.

Next, the wireless earpieces generate one or more alerts or communications in response to the radar measurements (step 606). The alerts or communications may also be communicated based on a user request, user preferences, or so forth. The alerts or communications may represent alerts, messages, tactile feedback, sounds, or audio communicated by the wireless earpieces or text messages, in-app communications, streaming content, packets, or other alerts or communications sent from the wireless earpieces to any number of other users/devices (directly or indirectly).

Next, the wireless earpieces communicate the one or more alerts or communications (step 608). The one or more alerts or communications may be sent directly (e.g., utilizing Bluetooth, Wi-Fi, NFMI, etc.), or through any number of networks or devices (e.g., Wi-Fi, LAN, cellular networks, cloud networks, mesh networks, etc.). In one embodiment, a receiving device may perform a specified activity based on the alert or communication. For example, a vehicle may prepare for a collision by tightening the seatbelts, braking, swerving, flashing lights, preparing or firing airbags, or so forth. In another example, the alert may indicate to one or more designated parties the user may have been injured (e.g., concussion, trauma, etc.). The wireless earpieces may also warn the user “watch out on your left” or any number of other applicable audio warnings. In one embodiment, the communications may include a command or instruction to a connected device. For example, a helmet worn by the user may cinch up or inflate one or more pouches/bags in response to determining a collision may be imminent.

The illustrative embodiments provide a system, method, and wireless earpieces for performing radar measurements. The radar sensors of the wireless earpieces may be internally or externally directed. Any number of pulse, pattern, active, passive, or continuous signal radar systems may be utilized. The radar sensors may be utilized to measure a physiological parameter from which information, such as heart rate based on the movement (displacement) of blood within the veins, arteries, tissues, or skin of the user's ear. The radar measurements may be effective even in the presence of sweat, water, dirt, dust, or during strenuous physical activities.

The illustrative embodiments may take the form of an entirely hardware embodiment, an entirely software embodiment (including firmware, resident software, micro-code, etc.) or an embodiment combining software and hardware aspects all generally referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, may include a non-transitory machine-readable medium having stored thereon instructions, which may be used to program a computing system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or another communications medium.

Computer program code for carrying out operations of the embodiments may be written in any combination of one or more programming languages, including an object-oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

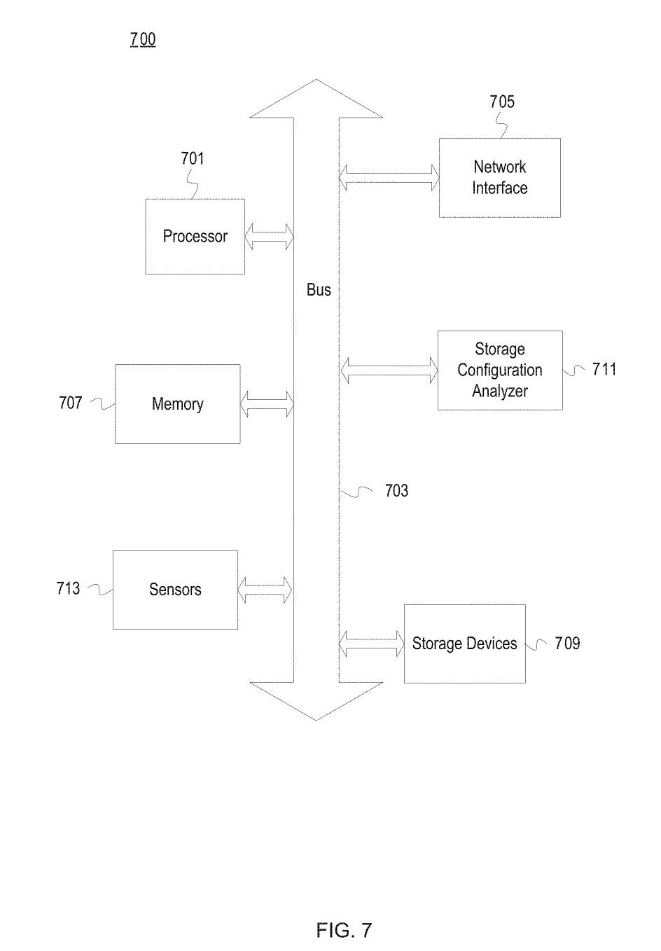

FIG. 7 depicts a computing system 700 in accordance with an illustrative embodiment. For example, the computing system 700 may represent a device, such as the wireless device 104 of FIG. 1. The computing system 700 includes a processor unit 701 (possibly including multiple processors, multiple cores, multiple nodes, and/or implementing multi-threading, etc.). The computing system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 703 (e.g., PCI, ISA, PCI-Express, HyperTransport®, InfiniBand®, NuBus, etc.), a network interface 705 (e.g., an ATM interface, an Ethernet interface, a Housing Relay interface, SONET interface, wireless interface, etc.), and a storage device(s) 709 (e.g., optical storage, magnetic storage, etc.). The system memory 707 embodies functionality to implement embodiments described above. The system memory 707 may include one or more instructions or code facilitating processing, adjusting signals, and otherwise utilizing radar measurements based on radar measurements performed by the one or more wireless earpieces. Code may be implemented in any of the other devices of the computing system 700. Any one of these functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further, realizations may include fewer or additional components not illustrated in FIG. 7 (e.g., video cards, audio cards, additional network interfaces, peripheral devices, etc.). The processor unit 701, the storage device(s) 709, and the network interface 705 are coupled to the bus 703. Although illustrated as being coupled to the bus 703, the memory 707 may be coupled to the processor unit 701.

Further shown are sensors 713 operably coupled to bus 703. Sensors 713 could be most any sensors, such as sensors 406, discussed in FIG. 4.

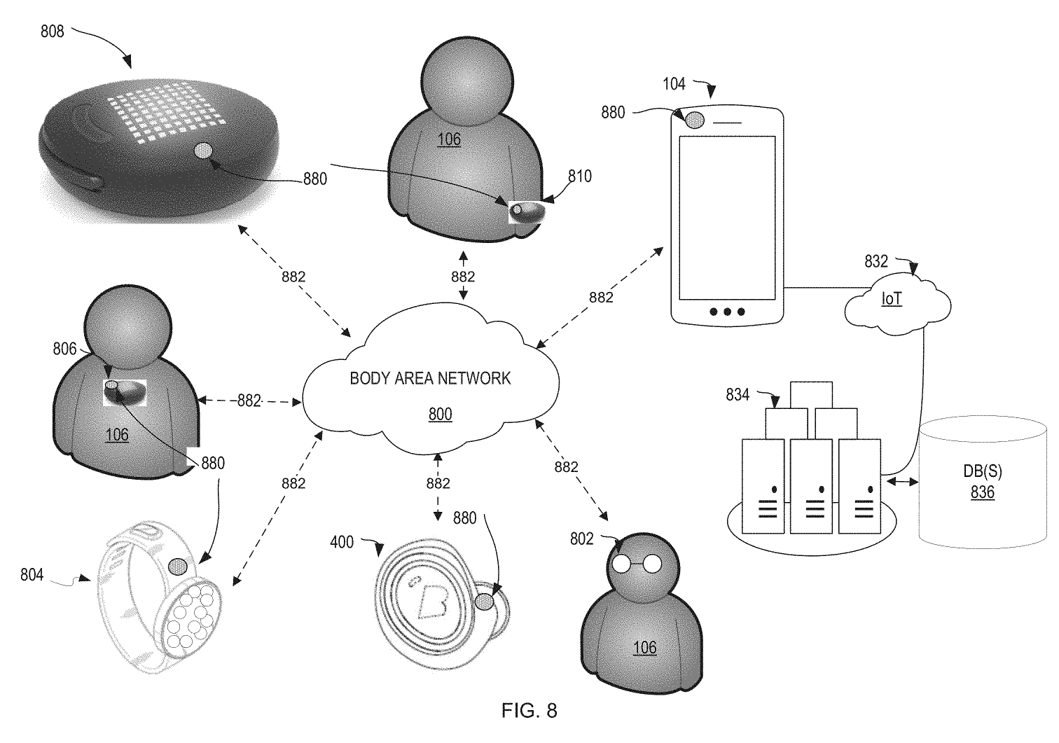

With reference to FIG. 8 a pictorial illustration of a body area network with wearable devices capable of performing radar measurements in accordance with illustrative embodiments is shown. Body area network (BAN) 800 provides for communication between wearable devices on user 106. Body area network 800 can allow for communications between wearable devices, such as smart/biometric eyewear 802, wireless earpieces 400, a smart/biometric watch 804, a smart/biometric wrist piece 810, a mobile phone 104, a smart biometric amulet 806, a smart biometric patch 808 an IoT (Internet of Things) network 832, a server platform 834 and a database server 336. While wearable devices are only shown as those in FIG. 8, the inventors fully contemplate other wearable devices could be substituted for those shown in FIG. 8 as well as wearable devices developed after the drafting of this specification. Further, communication along the BAN 800 cold be performed using most any communication method such as, a wireless network, Wi-Fi, cellular (e.g., 3G, 4G, 5G, PCS, GSM, etc.), Bluetooth, or other short-range or long-range radio frequency networks, signals, connections, or links without departing from the spirit of the invention.

Each of the wearable devices can have a radar sensor(s) 880 of their own. Which can be used in conjunction with the radar sensors 429 to provide biometric data, user identification and contextual awareness support for wireless earpieces 400.

FIG. 8 illustrates a body area network 800 created by the plurality of wearable electronic devices. Each wearable electronic device may be located at an area of the user's body capable of detecting biometric data, identifying the user 106 and providing contextual awareness for the user 106. Radar sensors 880 can detect physical actions including one or more actions related to the user's hands, fingers, thumbs, arms, elbows, shoulders, eyes, mouth, tongue, stomach, hips, knees, feet, or any other part of the body reasonably used as a KUA (Kinetic User Action). Each wearable electronic device may have a computer system 700 disposed within the housing which may be used to sense, process and communicate radar data from radar sensors 880. Each wearable electronic device may also transmit radar readings (882) to one or more wearable electronic devices for processing.

Each wearable electronic device may be further connected to a mobile phone 104, a computer 118, or one or more data servers 834 through a IoT network 832. IoT network 832 could also be the Internet, a Local Area Network, or a Wide Area Network, and the IoT network 832 may comprise one or more routers, one or more communications towers, or one or more Wi-Fi hotspots, and signals transmitted from or received by one of the wearable electronic devices traveling through one or more devices connected to the IoT network 832 before reaching their intended destination.

BAN 800 allows a user to utilize any number of wearable electronic devices, from 2 to N, where N is greater than 1. The use of N wearable electronic devices, attached to a body, capable of detecting internal and external events utilizing radar sensors 880 and communicating with one another through communication lines 882 to provide a decentralized user interface with a wearable electronic device.

In addition, information encoded in communications or transmissions received by the server platform 834 may be compared to data or information in the database server 836 to assist in verifying or authenticating the identity of users, provide location-dependent services to the user or users, develop a detailed profile of the user's surroundings.

Each wearable device within BAN 800 can improve a user's contextual awareness. Each wearable device can provide an overlap of radar information and possibly fill in gaps where gaps exist to provide a user with essentially a 360° contextual awareness surrounding for the user. This additional radar information only assists the user in performing the contextual awareness operations discussed in detail above in FIG. 4.

The features, steps, and components of the illustrative embodiments may be combined in any number of ways and are not limited specifically to those described. The illustrative embodiments contemplate numerous variations in the smart devices and communications described. The foregoing description has been presented for purposes of illustration and description. It is not intended to be an exhaustive list or limit any of the disclosure to the precise forms disclosed. It is contemplated other alternatives or exemplary aspects are considered included in the disclosure. The description is merely examples of embodiments, processes or methods of the invention. It is understood any other modifications, substitutions, and/or additions may be made, which are within the intended spirit and scope of the disclosure. For the foregoing, it can be seen the disclosure accomplishes at least all the intended objectives.

The previous detailed description is of a small number of embodiments for implementing the invention and is not intended to be limiting in scope. The following claims set forth several of the embodiments of the invention disclosed with greater particularity.

What is claimed is:

1. A method for utilizing wireless earpieces with radar, comprising:
activating one or more radar sensors of the wireless earpieces;
performing radar measurements of a user; and
analyzing the radar measurements to determine contextual awareness for the user.

2. The method of claim 1, further comprising:
sending the contextual awareness information to the user.

3. The method of claim 1, wherein the contextual awareness information is presented to the user audibly.

4. The method off claim 1, wherein there is an externally facing radar sensor.

5. The method of claim 1, wherein the radar sensors utilize Doppler radar to measure potential impact objects to the user.

6. The method of claim 1, further comprising the step of sending the contextual awareness information to a body area network (BAN).

7. The method of claim 4, further comprising contacting emergency assistance authorities if the externally facing radar detects an impact to the user.

8. The method of claim 1, further comprising:
audibly communicating information associated with the contextual information to the user through the wireless earpieces.

9. The method of claim 1, further comprising notifying the user of close quarter objects.

10. A wireless earpiece, comprising:
a housing for fitting in an ear of a user;
a processor controlling functionality of the wireless earpiece;
a plurality of sensors performs sensor measurements of the user, wherein the plurality of sensors includes one or more radar sensors; and
a transceiver communicating with at least a wireless device;
wherein the processor activates the one or more radar sensors and analyzes the radar measurements to determine contextual awareness associated with the user.

11. The wireless earpiece of claim 10, wherein the radar sensors include internally and externally facing radar sensors.

12. The wireless earpiece of claim 10, wherein the processor further communicates information associated with the contextual awareness to the user.

13. The wireless earpiece of claim 10, wherein the radar measurements from an externally facing radar indicates an impact with the user is imminent, wherein an alert is provided to the user through one or more speakers of the wireless earpiece.

14. The wireless earpiece of claim 10, wherein the one or more radar sensors include a plurality of radar sensors, wherein a first radar sensor sends a signal and wherein a second radar sensor measures reflection of the signal.

15. The wireless earpiece of claim 10, wherein the one or more radar sensors including a plurality of radar sensors are focused away from the user in different directions.

16. A method for utilizing wireless earpieces with radar, comprising:
activating an externally facing radar sensor of the wireless earpieces;
performing radar measurements; and
analyzing the radar measurements to determine contextual awareness of the user's surroundings.

17. The method of claim 16, further comprising the step of identifying any close objects to the user.

18. The method of claim 17, further comprising the step of notifying the user of any close objects to the user.

19. The method of claim 18, further comprising the step of notifying emergency service personal if an impact is detected.

20. The method of claim 19, further comprising notifying the user of a quickly closing object as a potential impact hazard.
